(19) United States
(12) Patent Application Publication
(10) Pub. No.: US 2011/0032794 A1
(43) Pub. Date: Feb. 10, 2011

(54) Undersea seismic monitoring network

(76) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/633,514

(22) Filed: Dec. 8, 2009

Related U.S. Application Data
(60) Provisional application No. 61/231,723, filed on Aug. 6, 2009.

(30) Foreign Application Priority Data
Aug. 6, 2009 (GB) 0913710.0

(51) Int. Cl. G01V 1/38; H04B 13/02

(52) U.S. Cl. 367/15; 367/134; 367/21

(57) ABSTRACT

The present invention provides an undersea seismic monitoring network, the monitoring network comprises at least one underwater vehicle and at least two monitoring stations located on the seabed, where each of the monitoring stations comprises at least one sensor for gathering seismic data and a radio modem for transmitting and receiving data to and from the underwater vehicle via a first wireless connection and where a second wireless connection is established between the monitoring stations, wherein the first wireless connection is formed by electromagnetic radiation through the water and the second wireless connection is formed by the propagation of an electromagnetic signal at least partially through the seabed.

### CROSS-REFERENCE TO RELATED APPLICATION

This application claims the benefit of U.S. 61/231,723 filed Aug. 6, 2009 and GB-0913710.0 filed Aug. 6, 2009, which applications are fully incorporated herein by reference.

### FIELD OF USE

The present invention relates to a wireless underwater network of sensors for the monitoring of seismic data and signals and the related systems for the gathering and processing of such data.

### DESCRIPTION OF THE RELATED ART

In the field of oil and gas exploration, seismic imaging over a large area of the seabed is an important method for optimization of oil and gas production, and for the assessment of the capacity of a particular field. The article entitled “Breakthrough for repeated seismic” by Halfdan Carstens, Geo ExPro; September 2004; pp 26-29, http://www.geoexpro.com/sfiles/8/21/6/file/Valhall_{—}26-29.pdf outlines a system for the gathering of seismic imaging data over a large area of the seabed.

The system for undersea seismic imaging taught by Carstens comprises a network or array of seismic monitoring stations which include sensors—such as geophones and hydrophones located at evenly spaced intervals (typically 50 metres) spanning a given area around a field of underwater exploration. The process of undersea seismic imaging is based on the generation of a known or well defined seismic event, for example, by a controlled detonation, and the monitoring of the effects of this event over a grid on which an array of monitoring stations or sensors are located. The mechanism for seismic imaging has two aspects, firstly there is the synchronization of the various sensors and monitors within the array, and secondly there is the recovery of the measured data from the sensors. Conventionally, seismic monitoring stations are linked together by a wired network of cable, and the data collected from the seismic sensors is gathered and stored by a main processing unit which is connected into the wired network; the wired network of cable also provides a means for the synchronization of the various sensors in the network.

Typically the seismic sensors and seismic monitoring stations record data at regular time intervals. Over the duration of one ‘survey’ the data collected per station could be in the order of one Gigabyte. The transfer of one Gigabyte of data in a reasonable length of time produces a requirement of the wired network for a data rate which is in the order of hundreds of kilobits per second.

The benefits of rolling out such a wired seismic motoring network are optimization of oil and gas production, the generation of information on the optimum drilling locations and the generation of information on field capacity and yield. The drawbacks of installing such a wired seismic motoring network are the cost of network deployment and the cost of maintenance thereof.

In particular, laying the wired network of cables which connect the array of seismic monitoring stations together and to the main processing unit in the monitoring network has a high associated cost. Typically, the cables are laid in channels cut at a depth of 1 metre in the seabed. The necessity for cutting deep channels in the seabed is driven by the extreme environment on the seabed. Moreover the cost associated when a breech or fault develops in the network of cables is high. Fault diagnosis and repair may often be impractical for a submerged wired system.

Current systems for undersea seismic imaging would be greatly improved if the network of cables which connect the various sensors of the array could be eliminated and if the transfer of data between the sensors and the main processing unit could take place wirelessly.

In particular, the use of electromagnetic (EM) radiation is preferable for wireless data transfer between seismic monitoring stations, as other forms of wireless data transfer: acoustic propagation and through water optical methods, are limited by several artifacts of the propagation method. For example, acoustic transfer is subject to interference arising from reflections from surfaces and objects, and optical transfer is subject to drop-out and distortion arising from turbidity.

Notwithstanding the benefits of electromagnetic radiation for wireless data transfer between seismic monitoring stations, to meet the requirements of the system as outlined above, the wireless transfer of data between seismic monitoring stations by electromagnetic radiation produces a requirement for a data rate of hundreds of kilobits per second at a distance of 50 m through seawater.

It is known that data transfer through conductive media such as seawater by wireless propagation of electromagnetic radiation is possible at low frequencies within a short range. US Patent Application Publication, US2006/0286931; “Underwater Communications System and Method”; Rhodes et al, teaches a method for the transmission of electromagnetic signals underwater at low data rates over a relatively short range. The problems of transmitting electromagnetic radiation through seawater arise principally from the conductivity of the medium and the corresponding high rate of attenuation of an electromagnetic signal. FIG. 2 of US Patent Application Publication US2006/0286931 shows that the rate of attenuation of an electromagnetic signal per meter of propagation through seawater increases with frequency and that increased range requires a lower carrier frequency of the electromagnetic signal. Thus, the data rate for radio communications decreases as the required range increases. For example, to achieve a propagation distance of 50 metres, the data rate would typically be in the order of hundreds of bits per second. This data rate is three orders of magnitude below the requirements of the system as outlined above to provide data transfer within an operationally acceptable timeframe.

In summary, it is clear from the prior art that in order to provide a wireless system or network for the transfer of data between undersea seismic monitoring stations two opposing demands must be met: a high frequency electromagnetic signal is needed to produce the required data rate for transferring data between the undersea monitoring stations and a low frequency electromagnetic signal is required to provide the required range.

### SUMMARY OF THE INVENTION

The present invention provides a solution to the above problems by dividing the data transfer into two separate categories, by identifying the optimum means for data transfer for each category, and by the introduction an underwater vehicle which can move between the monitoring stations and which can collect data from the monitoring stations sequentially.

The critical requirement for a communications link between the monitoring stations of an undersea seismic monitoring network is the transfer of a timing and synchronizing signal between the sensors. The timing and synchronization signal provides a mechanism by which measurements can be carried out over the entire network as a function of an absolute time reference, this communications link must be established at a distance determined by the spacing of the monitoring stations, typically 50 metres. Highly accurate time synchronization between undersea seismic monitoring stations is possible with a timing and synchronization signal having a carrier frequency in the order of 50 kHz; moreover, a frequency of 10 kHz is acceptable for most requirements. At these frequencies, propagation distances of 50 metres are achievable if the signal is transmitted at least partially through the seabed.

On the other hand, the critical requirement for a communications link between the monitoring stations and an underwater vehicle is fast download, necessitating a data rate of hundreds of kilobits per second and preferably several megabits per second. To meet this requirement, the present invention provides an underwater vehicle which is employed to move between the undersea monitoring stations sequentially. The underwater vehicle engages with the undersea monitoring station, activates the station and downloads the stored data via a subsea radio communications link. Downloading of data at a very high data rate up to 100 megabits per second can take place when the underwater vehicle is located within a short range of the monitoring station. As mentioned previously, the range of transmission for high data rate communications is limited by the high attenuation of an electromagnetic signal in seawater with distance. The range limitation of high-data rate undersea communications ensures that there is no danger of interference from adjacent undersea monitoring stations, and this creates the benefit that multiple underwater vehicles can operate in parallel, downloading data from multiple undersea monitoring stations without any need to code the signals to prevent interference. Range limitation also provides the capability that the process of data transfer can be instigated automatically when the underwater vehicle comes within the range of the monitoring station.

Accordingly it is an object of the present invention to provide an undersea seismic monitoring network, the monitoring network comprising at least one underwater vehicle and at least two monitoring stations located on the seabed, where each of the monitoring stations comprises at least one sensor for gathering seismic data and a radio modem for transmitting and receiving data to and from the underwater vehicle via a first wireless connection and where a second wireless connection is established between the monitoring stations, wherein the first wireless connection is formed by electromagnetic radiation through the water and the second wireless connection is formed by the propagation of an electromagnetic signal at least partially through the seabed.

In preferred embodiments the monitoring stations each comprise data storage devices for storage of measurements taken by the sensors. The gathered data is transferred from the storage devices to the underwater vehicle by the first wireless connection.

Preferably, the monitoring stations each comprise integrated rechargeable batteries. To facilitate the recharging of integrated rechargeable batteries, the monitoring stations may further include rechargeable input ports and the underwater vehicle may include an electrical power output port.

The underwater vehicle of the present invention can move from one monitoring station to another, and when the underwater vehicle comes within a range of the monitoring station, activation of the radio modem takes place. Activation may involve any one of the powering up of the radio modem or the transmission of handshaking signals between the monitoring station and the underwater vehicle. In this way, the radio modem can remain inactive until data is to be transferred from the monitoring station to the underwater vehicle, enabling the conservation of battery power. After the radio modem is activated, data which is stored in the monitoring station is transferred to the underwater vehicle by means of the first wireless connection. After the data has been transferred, the radio modem can become inactive once again, so as to conserve battery power. The underwater vehicle may also recharge the rechargeable battery of the monitoring station. In preferred embodiments, transfer of power from the underwater vehicle to the monitoring station takes place without direct conductive contact, for example, by magnetic coupling via magnetically ports of the underwater vehicle and monitoring station. Such a magnetic coupling is taught in United States Patent Application Publication: 2009/0102590; “Underwater Electrically Insulated Connection”; Rhodes et al. and is incorporated herein by reference.

Of critical importance for the analysis of seismic data from an array of monitoring stations, is the establishment of a precise time reference for each set of recorded data. Typically, this is achieved by the transmission of a timing and synchronization signal among all of the monitoring stations and sensors in the network to co-ordinate a common time reference.

In the following text the term ‘synchronization signal’ refers to a signal which provides an absolute time reference for absolute synchronization of undersea monitoring stations, and the term ‘timing signal’ refers to a signal which provides a reference frequency so that the passage of time can be measured accurately by each undersea monitoring station. The timing signal and synchronization signal may be combined into a single timing and synchronization signal, or may be separated.

Preferably the second wireless connection between the monitoring stations is used for the transmission of at least one of a timing reference signal and a synchronization reference signal among the monitoring stations of the network.

A typical timing and synchronization signal is formed of a periodic pulse modulated on a carrier signal of a given frequency. For transmission through the sea or seabed, the frequency of the carrier signal is limited by the required range of transmission. In typical implementations the monitoring stations are spaced apart by distances of 50 metres, and consequently the upper limit of the timing carrier signal and modulation spectrum is 50 kHz. In practical implementations, the carrier signal will have a carrier frequency of 10 kHz.

A second aspect of the present invention is to provide an undersea seismic monitoring system including one or more underwater vehicles and a plurality of monitoring stations located on the seabed, where each of the monitoring stations gathers seismic data and has an integrated radio modem for transmitting and receiving data to and from one of the under water vehicles. Each of the monitoring stations of the seismic monitoring system comprises at least one sensor for gathering seismic data and a radio modem for transmitting and receiving data to and from the under water vehicle via a first wireless connection. A second wireless connection is also established between the monitoring stations. The first wireless connection of the seismic monitoring system is formed by electromagnetic radiation through the water and the second wireless connection is formed by the propagation of an electromagnetic signal at least partially through the seabed.

Preferably, the plurality of monitoring stations are disposed in an array which is distributed over a given area of the seabed. In this way, seismic data can be gathered over a large area of the seabed so that a time dependent profile of the seismic data from the same area can be generated.

In preferred embodiments, the seismic data can be transferred from the underwater vehicles to a local docking station which may be located underwater or above water.

The gathered data may be analyzed by a computer or computer program and results can be extracted giving information relating to the properties, and extent of the material lying below the seabed.

### BRIEF DESCRIPTION OF DRAWINGS

Various aspects of the invention will now be described by way of example only and with reference to the accompanying drawings, of which:

FIG. 1 shows an undersea seismic monitoring network according to the present invention.

FIG. 2 shows a block diagram of the integral components of an undersea monitoring station forming part of the seismic monitoring network of the present invention.

FIG. 3 shows a block diagram of the integral components of an underwater vehicle forming part of the seismic monitoring network of the present invention.

FIG. 4 shows a block diagram of a high data rate electromagnetic communications modem forming part of the seismic monitoring network of the present invention.

### DETAILED DESCRIPTION OF INVENTION

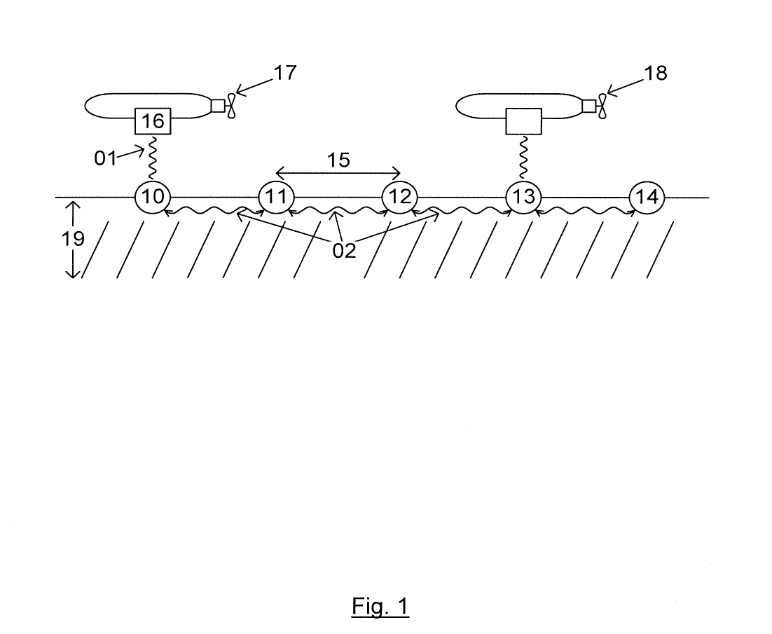

FIG. 1 shows a drawing of an undersea seismic monitoring network according to an embodiment of present invention. The undersea seismic monitoring network of FIG. 1 comprises an underwater vehicle 17, onto which a radio modem 16 is mounted, and an array of undersea monitoring stations 10, 11, 12, 13, and 14, spaced at regular intervals 15 on the seabed 19. Depending on the specific implementation, monitoring stations 10, 11, 12, 13, and 14, may be mounted on the surface of the seabed, or may be trenched; the choice is based principally on the conditions of the local environment, and the nature of the seabed.

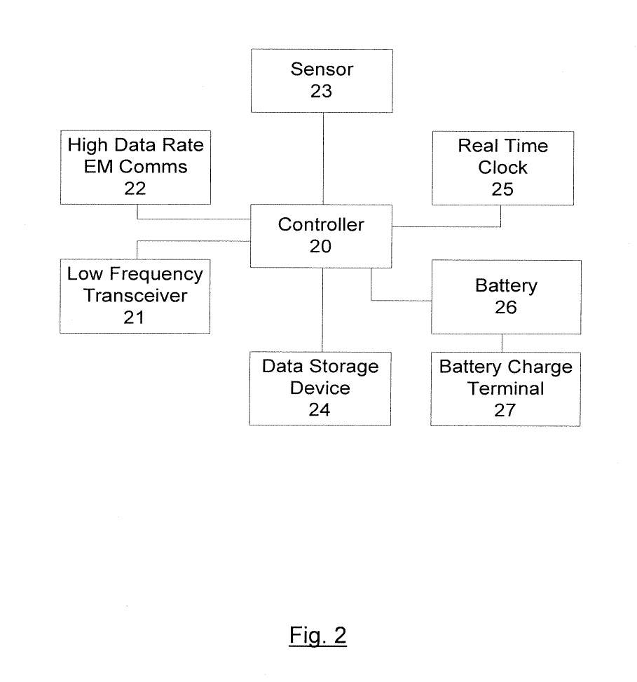

FIG. 2 shows a block diagram of the integral components of an undersea monitoring station 10, 11, 12 13 and 14 of the undersea seismic monitoring network of FIG. 1. Undersea seismic monitoring stations 10, 11, 13 and 14 each comprise a sensor 23 for measuring seismic data, which is connected to controller 20. Controller 20 comprises a programmable integrated circuit and other electronic devices as required and as would be known to a person skilled in the art of system design. Measured data from sensor 23 is stored in data storage device 24 which is also connected to controller 20. A high data rate EM communications modem 22 is provided to establish a first wireless communications link 01 by electromagnetic radiation between undersea monitoring station 10, 11, 12, 13 and 14 and underwater vehicle 17. A low frequency transceiver module 21 is provided to transmit a electromagnetic timing and synchronization signal 02 between monitoring stations 10, 11, 12, 13 and 14. A real-time clock 25 is also connected to controller 20, and this allows a local timing reference to be stored along with measured data from sensor 23 in data storage device 24. An output from low frequency transceiver module 21 connected to controller 20 provides an input to synchronize real time clock 25. This input is derived from a timing and synchronization signal 02 which is transmitted partially through seabed 19 and which is received and demodulated by low frequency transceiver module 21. At the same time controller 20 provides an output signal which is re-modulated by low frequency transceiver module 21, and which is transmitted through the seabed so that the timing and synchronization signal 02 is passed from one undersea monitoring station 10, 11, 12, 13 and 14 to another, and hence is common to the entire seismic monitoring network of the present invention. Preferably, the timing and synchronization signal 02 has a low carrier frequency; the frequency range of this carrier signal can vary from 10 Hz to 50 kHz. Advantageously the carrier frequency of timing and synchronization signal 02 is approximately 10 kHz. To avoid cross interference between the transmit and receive sections of Low Data Rate EM Communications Module 21, the transmitted and received signals are multiplexed in the time domain; alternatively the multiplexing of synchronization signal 02 can be carried out in the frequency domain.

Electrical power for undersea monitoring stations 10, 11 12 13 and 14 of FIG. 1 is provided by a rechargeable internal battery 26 of FIG. 2. A rechargeable battery terminal 27 is located on the outside of undersea monitoring stations 10, 11 12 13 and 14, and this facilitates periodic recharging of internal battery 26.

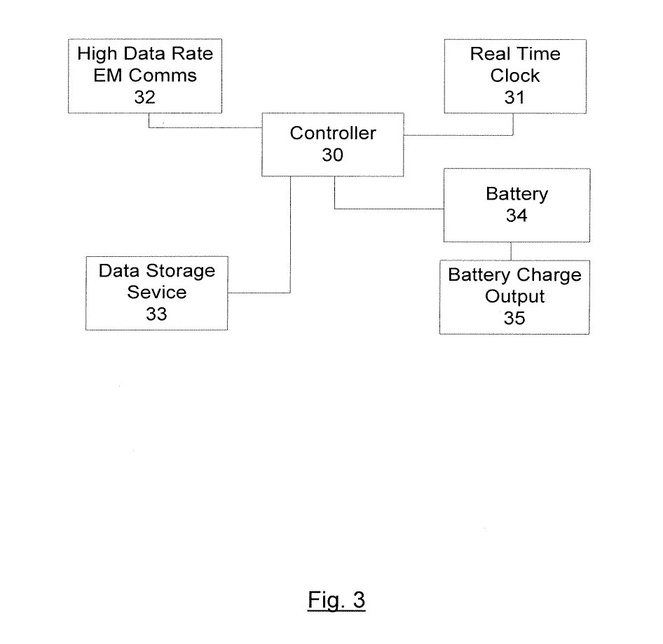

FIG. 3 shows a block diagram of the integral components the network equipment 16 mounted on underwater vehicle 17 of the undersea seismic monitoring network of FIG. 1. Network equipment 16, depicted in FIG. 3 comprises a controller 30, a high data rate EM communications modem 32, a data storage device 33 connected to controller 30, a real time clock connected to controller 30, a battery 34 which provides power for network equipment 16 and a battery charge output port. High data rate EM communications modem 32 sends or receives data via electromagnetic radiation to undersea monitoring stations 10, 11, 12, 13, and 14 of FIG. 1 thereby establishing wireless communications link 01 between underwater vehicle and undersea monitoring stations 10, 11, 12, 13 and 14. Data is passed to and from high data rate EM communications modem 32 via controller 30. Data storage device stores data received via high data rate EM communications modem 32 and passed to it via controller 30. Controller 30 of network equipment 16 comprises a programmable integrated circuit and other electronic devices as required and as would be known to a person skilled in the art of system design. A real-time clock 31 is also connected to controller 30, and this provides an absolute time synchronization signal which may be passed to undersea monitoring stations 10, 11, 12, 13, and 14 of FIG. 1 for checking. Preferably the frequency of the carrier signal of wireless communications link 01 is higher than that of timing and synchronization signal 02 and the frequency of this carrier signal is in the range from 10 kHz to 50 MHz. In use, the carrier frequency of wireless communications link 01 will be as high as practical in order to facilitate a maximum speed of data transfer between underwater vehicle 17 and undersea monitoring stations 10, 11, 12, 13 and 14 of FIG. 1. However, the range of operation decreases as the carrier frequency increases, so the proximity of underwater vehicle 17 to any one of wireless monitoring stations 10, 11, 12, 13, and 14 determines the upper limit of the carrier frequency of wireless communications link 01. Adaptive carrier frequency based on range may be deployed whereby the carrier frequency of communications link 01 and its modulated symbol rate is increased as the range decreases in order to provide the highest practical data transfer rate.

For fast data transfer between underwater vehicle 17 and undersea monitoring stations 10, 11, 12, 13 and 14, an antenna (not shown) of underwater vehicle 17 will come within a distance of 1 meter of an antenna (not shown) of undersea monitoring station during data transfer.

It will be noted that undersea monitoring stations 10, 11, 12, 13 and 14 of FIG. 1 are typically spaced apart by distances of 50 metres, and since the proximity of underwater vehicle 17 with one of undersea monitoring stations 10, 11, 12, 13 and 14 is much less, negligible electromagnetic signal amplitude will be present at adjacent nodes and local communication between underwater vehicle 17 and any of undersea monitoring stations 10, 11, 12, 13 and 14 can occur independently at a given time. This range limitation of electromagnetic communications link 01 provides the benefit that data transfer between a plurality of undersea monitoring stations 10, 11, 12, 13 and 14 can take place between a plurality of underwater vehicles, 17 and 18 at the same time. This property represents a form of spatial diversity which allows simultaneous frequency re-use at individual nodes.

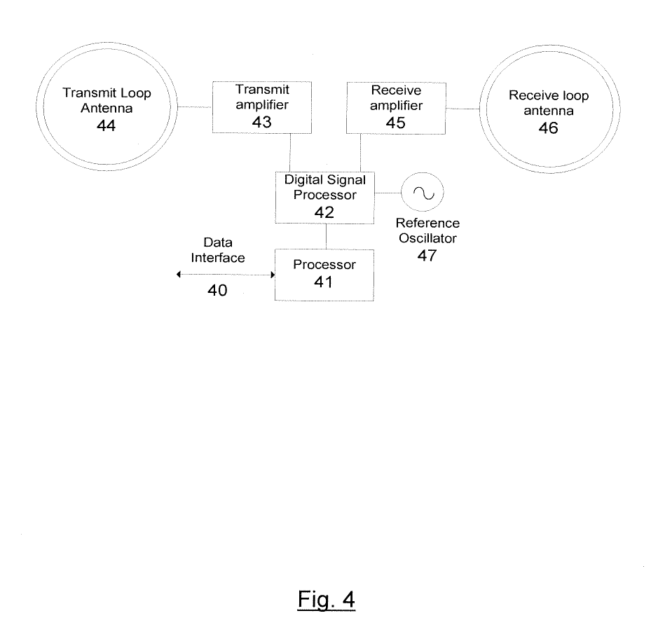

FIG. 4 shows a block diagram of the main features of high data rate EM communications modem 22 of FIG. 2. The same diagram might equally be applied to high data rate EM communications modem 32 of FIG. 3. In transmit mode, data interface 40 feeds data to high data rate EM communications modem 22, 32. A reference oscillator 47 provides a carrier signal at an appropriate frequency; this is modulated by the data signal in digital signal processor 42. An output from digital signal processor 42 is fed to transmit amplifier 43 and then to transmit loop antenna 44. Transmit loop antenna 44 may consist of 10 turns of electrically insulated wire, closely spaced to form a compact bundle, arranged to form a circular loop with a 1 m internal diameter. In receive mode, an electromagnetic signal (not shown) is received by receive loop antenna 46 and is passed to receive amplifier 45 where it is amplified and passed on to digital signal processor 42 and demodulated using the signal from reference oscillator 47. The demodulated signal is then fed to processor 41, where the data is converted into the required format and is outputted from high data rate EM communications modem 22, 32 via data interface 40. Receive loop antenna 46 may consist of 100 turns of electrically insulated wire, closely spaced to form a compact bundle, arranged to form a circular loop with a 1 m internal diameter.

In use, the underwater vehicles 17, 18 of FIG. 1 move from one monitoring station 10, 11, 12, 13 and 14 to another in a pre-programmed manner. When an underwater vehicle 17, 18 comes within range of a monitoring station 10, 11, 12, 13 and 14, activation of high data rate EM communications modem 22 takes place. Activation involves the powering up of high data rate EM communications modem 22 and the transmission of handshaking signals between the undersea monitoring station 10, 11, 12, 13 and 14 and underwater vehicle 17, 18 via wireless communications link 01. In this way, high data rate EM communications modem 22 remains inactive until data is to be transferred from undersea monitoring station 10, 11, 12, 13 and 14 to underwater vehicle 17, 18, enabling the conservation of battery power. After high data rate EM communications modem 22 is activated, data which is stored in data storage device 24 is transferred to underwater vehicle 17 by means of wireless communications link 01. After the data has been transferred, high data rate EM communications modem 22 becomes inactive once again, so as to conserve battery power.

As data is being transferred, underwater vehicle 17, 18 may also recharge rechargeable internal battery 26 of monitoring station 10, 11, 12, 13 and 14. Transfer of power from the underwater vehicle 17, 18 to monitoring station 10, 11, 12, 13 and 14 takes place via battery terminal 27 of FIG. 2 and battery charge output 35 of FIG. 3. Advantageously, power transfer takes place without direct contact, for example, by magnetic coupling via battery terminal 27 of FIG. 2 and battery charge output 35 of FIG. 3.

Another benefit of the range limitation of wireless communications link 01 is that undersea monitoring stations 10, 11, 12, 13 and 14 can be programmed to become active only when an underwater vehicle 17, 18 comes within range of transmission. Underwater vehicle 17 generates transmit signals as it travels about the deployed network. Receive amplifier 45 within high data rate EM communications modem 22 monitors the received signal strength and only powers up the other modem components once a received signal is detected which indicates the presence of a vehicle which may desire to communicate. Once powered up, high data rate EM communications modem 22 will generate a transmit pulse to initiate handshaking and communications will then follow to facilitate transfer of stored monitoring data from data storage device 24 of FIG. 2 to data storage device 33 of network equipment 16 mounted on underwater vehicle 17, 18. After a predefined period of inactive communications the sensor modem will return to a low power standby state to conserve battery power.

Those familiar with communications and sensing techniques will understand that the foregoing descriptions are just examples of the principle according to the present invention. In particular, to achieve some or most of the advantages of this invention, practical implementations may not necessarily be exactly as exemplified and can include variations within the scope of the invention.

Also, whilst the systems and methods described are generally applicable to seawater, fresh water and any brackish composition in between, because relatively pure fresh water environments exhibit different electromagnetic propagation properties from saline, seawater, different operating conditions may be needed in different environments. Any optimization required for specific saline constitutions will be obvious to any practitioner skilled in this area. Accordingly the above description of the specific embodiment is made by way of example only and not for the purposes of limitation. It will be clear to the skilled person that minor modifications may be made without significant changes to the operation described.

The present invention is not limited to the embodiments described herein.

What is claimed is:

1. An undersea seismic monitoring network,
said monitoring network comprising at least one underwater vehicle and at least two monitoring stations located on a seabed, each of said at least two monitoring stations comprising at least one sensor for gathering seismic data and a radio modem for transmitting and receiving data to and from said at least one underwater vehicle via a first wireless connection
and where a second wireless connection is established between said at least two monitoring stations,
wherein said first wireless connection is formed by electromagnetic radiation through the water and said second wireless connection is formed by the propagation of an electromagnetic signal at least partially through the seabed.

2. An undersea seismic monitoring network as claimed in claim 1,
each of said at least two monitoring stations further comprising a respective storage device, said respective storage device being used to store data recorded by said at least one sensor of said monitoring station.

3. An undersea seismic monitoring network as claimed in claim 2 wherein said stored data of said respective storage device is transferred to said at least one underwater vehicle via said first wireless connection.

4. An undersea seismic monitoring network as claimed in claim 1,
each of said at least two monitoring stations further comprising a respective timing device.

5. An undersea seismic monitoring network as claimed in claim 4, wherein a timing signal is transmitted between said at least two monitoring stations via said second wireless connection.

6. An undersea seismic monitoring network as claimed in claim 4, wherein said at least one underwater vehicle transmits a clock synchronization signal to synchronize each said timing device.

7. An undersea seismic monitoring network as claimed in claim 1 wherein said first electromagnetic signal can support a higher bit rate than said second electromagnetic signal.

8. An undersea seismic monitoring network as claimed in claim 7 wherein said first wireless connection has a carrier frequency in the range from 10 kHz to 50 MHz.

9. An undersea seismic monitoring network as claimed in claim 7 wherein said second wireless connection has a carrier frequency in the range from 10 Hz to 50 kHz.

10. An undersea seismic monitoring network as claimed in claim 1, wherein a respective region about each of said at least two monitoring stations within which said data transmitted by said radio modem of said monitoring station can be received by said at least one underwater vehicle defines a respective range of said monitoring station.

11. An undersea seismic monitoring network as claimed in claim 10 wherein said radio modem is activated when said at least one underwater vehicle comes within said range of said monitoring station.

12. An undersea seismic monitoring network as claimed in claim 11 wherein said activation of said radio modem comprises the powering up of and the transmission and reception of a handshaking signal to and from said at least one underwater vehicle via said first wireless connection.

13. An undersea seismic monitoring network as claimed in claim 11 wherein said transfer of data via said first wireless connection takes place for a given period of time after said activation of said radio modem.

14. An undersea seismic monitoring network as claimed in claim 1,
each of said at least two monitoring stations further comprising a respective rechargeable battery, said rechargeable battery providing power for said monitoring station.

15. An undersea seismic monitoring network as claimed in claim 14, each of said at least two monitoring stations further comprising a respective battery recharging input port.

16. An undersea seismic monitoring network as claimed in claim 15, said underwater vehicle comprising a battery recharging output port.

17. An undersea seismic monitoring network as claimed in claim 16, wherein power transfer from said battery recharging output port of said underwater vehicle to said respective battery recharging input port of said monitoring station takes place by magnetic coupling.

18. An undersea seismic monitoring network as claimed in claim 1 wherein said at least one sensor of said at least two monitoring stations detects mechanical vibrations in the seabed.

19. An undersea seismic monitoring network as claimed in claim 1 wherein said at least one sensor of said at least two monitoring stations is a piezoelectric sensor.

20. A system for undersea seismic monitoring,
said system comprising at least one underwater vehicle and at least two monitoring stations located on the seabed which gather seismic data,
each of said monitoring stations comprising a storage device for storing said gathered data, an integrated timing device, and a radio modem for transmitting and receiving data to and from said at least one underwater vehicle via a first wireless connection
and where a second wireless connection is established between said at least two monitoring stations,
wherein said first wireless connection is formed by electromagnetic radiation through the water and said second wireless connection is formed by the propagation of an electromagnetic signal at least partially through the seabed.

21. The system for undersea seismic monitoring of claim 20 wherein said first wireless connection is capable of supporting a higher bit rate than said second wireless connection.

22. The system for undersea seismic monitoring of claim 20 wherein said first electromagnetic signal has a carrier frequency in the range from 10 kHz to 50 MHz.

23. The system for undersea seismic monitoring of claim 20 wherein said second electromagnetic signal has a carrier frequency in the range from 10 Hz to 50 kHz.

24. The system for undersea seismic monitoring of claim 20 wherein said stored data is transferred to said at least one underwater vehicle via said first wireless connection.

25. The system for undersea seismic monitoring of claim 24 wherein said at least one underwater vehicle has an interface to download said stored data to a local docking station.

26. The system for undersea seismic monitoring of claim 20 further comprising an array of monitoring stations which gather seismic data over a predefined area.

27. The system for undersea seismic monitoring of claim 26 wherein said gathered data forms a time dependent profile of seismic data over said predefined region.

28. The system for undersea seismic monitoring of claim 26 said gathered data is analyzed by a computer or a computer program.

29. The system for undersea seismic monitoring of claim 20 wherein said at least one underwater vehicle comprising a battery recharging output port, and said at least two undersea monitoring stations comprising a respective battery recharging input port.

30. The system for undersea seismic monitoring of claim 29 wherein said battery recharging output port provides power for recharging a respective internal battery of said monitoring stations via respective magnetically coupled input terminals of said monitoring stations.
